(19) United States
(12) Patent Application Publication
(10) Pub. No.: US 2025/0361635 A1
(43) Pub. Date: Nov. 27, 2025

(54) CONTROL DEVICE FOR ELECTROLYSIS SYSTEM AND ELECTROLYSIS SYSTEM

(71) Applicant: HONDA MOTOR CO., LTD., TOKYO (JP)

(72) Inventor: Tomohiro TAKAYANAGI, Wako-shi (JP)

(21) Appl. No.: 19/205,231

(22) Filed: May 12, 2025

(30) Foreign Application Priority Data
May 21, 2024 (JP) 2024-082497

(51) Int. Cl. C25B 15/023; C25B 1/04; C25B 9/73; C25B 15/08

(52) U.S. Cl. CPC C25B 15/023; C25B 1/04; C25B 9/73; C25B 15/081

(57) ABSTRACT

A control device for an electrolysis system includes a deterioration prediction unit that predicts a degree of deterioration of each of a water electrolysis stack and a compression stack, and a supplied electrical current control unit that controls an electrical current that is supplied to the water electrolysis stack and an electrical current that is supplied to the compression stack, wherein the supplied electrical current control unit controls the electrical current that is supplied to the stack having a larger degree of deterioration from among the water electrolysis stack and the compression stack to be constant, and adaptively controls the electrical current that is supplied to the stack having a smaller degree of deterioration from among the water electrolysis stack and the compression stack.

### CROSS-REFERENCE TO RELATED APPLICATIONS

This application is based upon and claims the benefit of priority from Japanese Patent Application No. 2024-082497 filed on May 21, 2024, the contents of which are incorporated herein by reference.

### BACKGROUND OF THE INVENTION

### Field of the Invention

The present disclosure relates to a control device for an electrolysis system, and an electrolysis system.

### Description of the Related Art

In recent years, research and development have been conducted on an electrolysis system that contributes to energy efficiency in order to ensure that more people have access to affordable, reliable, sustainable and modern energy.

For example, in JP 7421581 B2, there is disclosed an electrolysis system equipped with a water electrolysis device and a compression device (a compression device). The water electrolysis device electrolyzes water by supplying an electrical current to a water electrolysis stack. The compressor compresses a hydrogen gas by supplying an electrical current to a compression stack into which the hydrogen gas that is generated in the water electrolysis stack is introduced. The electrolysis system is controlled by a control device.

### SUMMARY OF THE INVENTION

There is a long awaited need for a more satisfactory control device for an electrolysis system and an electrolysis system.

The present invention has the object of solving the aforementioned problem.

A first aspect of the present disclosure is characterized by a control device for an electrolysis system, and the electrolysis system includes a water electrolysis device configured to electrolyze water by supplying an electrical current to a water electrolysis stack, and a compression device configured to compress a hydrogen gas by supplying an electrical current to a compression stack into which the hydrogen gas that is generated in the water electrolysis stack is introduced, wherein the control device for the electrolysis system includes a deterioration prediction unit configured to predict a degree of deterioration of each of the water electrolysis stack and the compression stack, and a supplied electrical current control unit configured to control an electrical current that is supplied to the water electrolysis stack and an electrical current that is supplied to the compression stack, and wherein the supplied electrical current control unit controls the electrical current that is supplied to the water electrolysis stack or the compression stack having a larger degree of deterioration to be constant, and adaptively controls the electrical current that is supplied to the water electrolysis stack or the compression stack having the smaller degree of deterioration.

A second aspect of the present disclosure is characterized by an electrolysis system equipped with the control device according to the first aspect.

According to the present disclosure, it is possible to obtain a more satisfactory control device for an electrolysis system, and a more satisfactory electrolysis system.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a schematic diagram of an energy system equipped with an electrolysis system according to an embodiment;

FIG. 2 is a cross-sectional explanatory diagram of a water electrolysis cell;

FIG. 3 is a cross-sectional explanatory diagram of a compression cell;

FIG. 4 is a block diagram for describing a control device; and

FIG. 5 is a flowchart for describing a method of controlling the electrolysis system.

### DETAILED DESCRIPTION OF THE INVENTION

In an electrolysis system, in a water electrolysis stack, a portion of hydrogen gas that is generated by the electrolysis of water permeates through an electrolyte membrane and is guided to an oxygen gas transport path. A flow amount of the hydrogen gas that permeates through the electrolyte membrane varies depending on the pressure in the oxygen gas transport path and the temperature of the water electrolysis stack and the like. Therefore, even if a constant electrical current is supplied to the water electrolysis stack, the flow amount of the hydrogen gas output from the water electrolysis stack fluctuates. In such a state, if a constant electrical current is supplied to the compression stack and compresses the hydrogen gas, since the amount of the hydrogen gas existing inside the flow path for guiding to the compression stack the hydrogen gas that is generated in the water electrolysis stack will increase or decrease, it may become impossible for the hydrogen gas to be compressed efficiently by the compression stack.

In order to adjust the amount of the hydrogen gas existing inside the flow path for guiding the hydrogen gas that is generated in the water electrolysis stack to the electrolysis stack, for example, in the case that the electrical current that is supplied to the water electrolysis stack is adaptively controlled and that the electrical current supplied to the compression stack is controlled to be constant, the water electrolysis stack will become more easily susceptible to deterioration in comparison with the compression stack. On the other hand, in the case that the electrical current that is supplied to the water electrolysis stack is controlled to be constant and that the electrical current supplied to the compression stack is adaptively controlled, the compression stack will become more easily susceptible to deterioration in comparison with the water electrolysis stack. In the present disclosure, an electrolysis system control device and an electrolysis system can be provided that are capable of efficiently compressing the hydrogen gas by the compression stack while suppressing a variation in the level of deterioration between the water electrolysis stack and the compression stack.

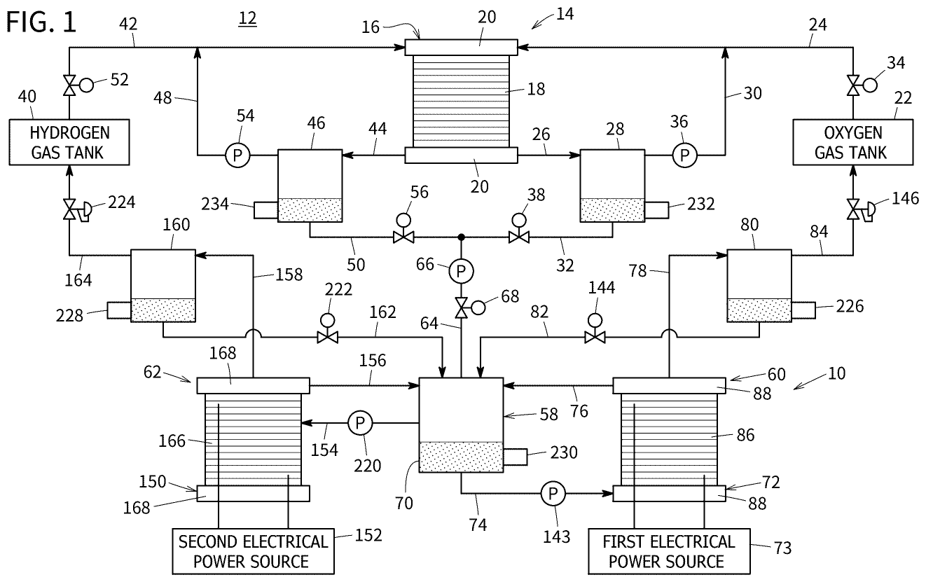

FIG. 1 is a schematic diagram of an energy system 12 equipped with an electrolysis system 10 according to an embodiment. As shown in FIG. 1, the energy system 12 is a circulatory renewable energy system. The energy system 12 is a system in which a fuel cell system 14 and the electrolysis system 10 are combined. The fuel cell system 14 causes electrical power and water to be generated by means of an electrochemical reaction between the oxygen gas and the hydrogen gas. The electrolysis system 10 electrolyzes the water and thereby causes the oxygen gas and the hydrogen gas to be generated. The electrolysis system 10 utilizes the water that is generated in the fuel cell system 14. The fuel cell system 14 utilizes the oxygen gas and the hydrogen gas that are generated in the electrolysis system 10.

Such an energy system 12 can be positioned, for example, on the Earth or on the surface of the moon. Further, the energy system 12 may also be installed on an artificial satellite such as the International Space Station (ISS) or the like.

The fuel cell system 14 is equipped with a fuel cell stack 16. The fuel cell stack 16 is a polymer electrolyte fuel cell (PEFC). The fuel cell stack 16 includes a plurality of electrical power generating cells 18, and a pair of end plates 20. The plurality of electrical power generating cells 18 are stacked mutually on one another. The pair of end plates 20 sandwich and hold the plurality of electrical power generating cells 18 therebetween in the stacking direction of the plurality of electrical power generating cells 18.

A detailed illustration of the electrical power generating cells 18 is omitted. Each of the electrical power generating cells 18 includes a membrane electrode assembly (MEA), and a pair of separators. The membrane electrode assembly is sandwiched between the pair of separators. The membrane electrode assembly includes an electrolyte membrane, an anode, and a cathode. The electrolyte membrane is a solid polymer electrolyte membrane. The electrical power generating cells 18 generate electrical power by means of an electrochemical reaction between the hydrogen gas and the oxygen gas. When the electrical power generating cell 18 generates electrical power, water is generated at the cathode electrode.

The fuel cell system 14 is further equipped with an oxygen gas tank 22, an oxygen gas supply path 24, an oxygen gas discharge path 26, a gas/liquid separator 28, an oxygen gas circulation path 30, and a first drainage path 32. A high pressure oxygen gas is filled in the oxygen gas tank 22. The oxygen gas supply path 24 supplies the oxygen gas that is filled in the oxygen gas tank 22 to the fuel cell stack 16. An opening/closing valve 34 is provided in the oxygen gas supply path 24. The opening/closing valve 34 opens and closes the oxygen gas supply path 24.

The oxygen gas discharge path 26 connects the fuel cell stack 16 and the gas/liquid separator 28 to each other. An oxygen exhaust gas (an off gas) that is discharged from the fuel cell stack 16 flows through the oxygen gas discharge path 26. The oxygen exhaust gas contains an unreacted oxygen gas that has not reacted in the electrical power generating cells 18. Further, the oxygen exhaust gas also contains water (water vapor) that is generated at the cathodes of the electrical power generating cells 18.

The gas/liquid separator 28 separates into a gas and a liquid the oxygen exhaust gas that is guided from the oxygen gas discharge path 26. Stated otherwise, the gas/liquid separator 28 removes the moisture from the oxygen exhaust gas. The gas/liquid separator 28 stores the water (liquid water) that is separated from the oxygen exhaust gas. The oxygen gas circulation path 30 connects the gas/liquid separator 28 and the oxygen gas supply path 24 to each other. The oxygen gas circulation path 30 guides the oxygen exhaust gas from which the moisture has been removed by the gas/liquid separator 28 to the oxygen gas supply path 24. An oxygen pump 36 is provided in the oxygen gas circulation path 30. The oxygen pump 36 delivers the oxygen exhaust gas that flows through the oxygen gas circulation path 30, to the oxygen gas supply path 24.

The first drainage path 32 is a flow path for discharging the water that is stored in the gas/liquid separator 28 to the exterior of the gas/liquid separator 28. A first drainage valve 38 is provided in the first drainage path 32. The first drainage valve 38 is an opening/closing valve that opens and closes the first drainage path 32.

The fuel cell system 14 is further equipped with a hydrogen gas tank 40, a hydrogen gas supply path 42, a hydrogen gas discharge path 44, a gas/liquid separator 46, a hydrogen gas circulation path 48, and a second drainage path 50. A high pressure hydrogen gas is filled in the hydrogen gas tank 40. The hydrogen gas supply path 42 supplies the hydrogen gas that is filled in the hydrogen gas tank 40 to the fuel cell stack 16. An opening/closing valve 52 is provided in the hydrogen gas supply path 42. The opening/closing valve 52 opens and closes the hydrogen gas supply path 42.

The hydrogen gas discharge path 44 connects the fuel cell stack 16 and the gas/liquid separator 46 to each other. A hydrogen exhaust gas (an off gas) that is discharged from the fuel cell stack 16 flows through the hydrogen gas discharge path 44. The hydrogen exhaust gas contains an unreacted hydrogen gas that has not reacted in the electrical power generating cells 18. Further, the hydrogen exhaust gas also contains moisture that has permeated from the cathodes of the electrical power generating cells 18 through the electrolyte membrane and that is guided to the anodes.

The gas/liquid separator 46 separates into a gas and a liquid the hydrogen exhaust gas that is guided from the hydrogen gas discharge path 44. Stated otherwise, the gas/liquid separator 46 removes the moisture from the hydrogen exhaust gas. The gas/liquid separator 46 stores the water (liquid water) that is separated from the hydrogen exhaust gas. The hydrogen gas circulation path 48 connects the gas/liquid separator 46 and the hydrogen gas supply path 42 to each other. The hydrogen gas circulation path 48 guides the hydrogen exhaust gas from which the moisture has been removed by the gas/liquid separator 46 to the hydrogen gas supply path 42. A hydrogen pump 54 is provided in the hydrogen gas circulation path 48. The hydrogen pump 54 delivers the hydrogen exhaust gas that flows through the hydrogen gas circulation path 48 to the hydrogen gas supply path 42.

The second drainage path 50 is a flow path for discharging the water that is stored in the gas/liquid separator 46 to the exterior of the gas/liquid separator 46. A second drainage valve 56 is provided in the second drainage path 50. The second drainage valve 56 is an opening/closing valve that opens and closes the second drainage path 50.

The fuel cell system 14 can be equipped with constituent elements apart from those described above. Specifically, the fuel cell system 14 can be equipped with, for example, a cooling device in order to allow a cooling medium to flow through the fuel cell stack 16.

The electrolysis system 10 is equipped with a gas/liquid separator 58, a water electrolysis device 60, and a compression device 62. A water supply path 64 is connected to the gas/liquid separator 58 of the electrolysis system 10. The water supply path 64 is connected to the first drainage path 32 and the second drainage path 50. The water supply path 64 guides the water that is guided from the first drainage path 32 and the water that is guided from the second drainage path 50 to the gas/liquid separator 58. A pump 66 and an opening/closing valve 68 are disposed in the water supply path 64. The pump 66 delivers the water that flows through the water supply path 64 to the gas/liquid separator 58. The opening/closing valve 68 opens and closes the water supply path 64. The gas/liquid separator 58 includes a storage unit 70 that stores the water. The water that is stored in the storage unit 70 of the gas/liquid separator 58 is used in the water electrolysis device 60.

In the water electrolysis device 60, by the water (pure water) being electrolyzed, the oxygen gas and the hydrogen gas are generated. The water electrolysis device 60, for example, is a solid polymer water electrolysis device.

The water electrolysis device 60 includes a water electrolysis stack 72, a first electrical power source 73, a water electrolysis supply path 74, a water electrolysis discharge path 76, a first oxygen gas transport path 78, a gas/liquid separator 80, a third drainage path 82, and a second oxygen gas transport path 84. The water electrolysis stack 72 includes a plurality of water electrolysis cells 86 and a pair of end plates 88. The plurality of water electrolysis cells 86 are stacked mutually on one another. The pair of end plates 88 sandwich the plurality of water electrolysis cells 86 therebetween in the stacking direction of the water electrolysis cells 86.

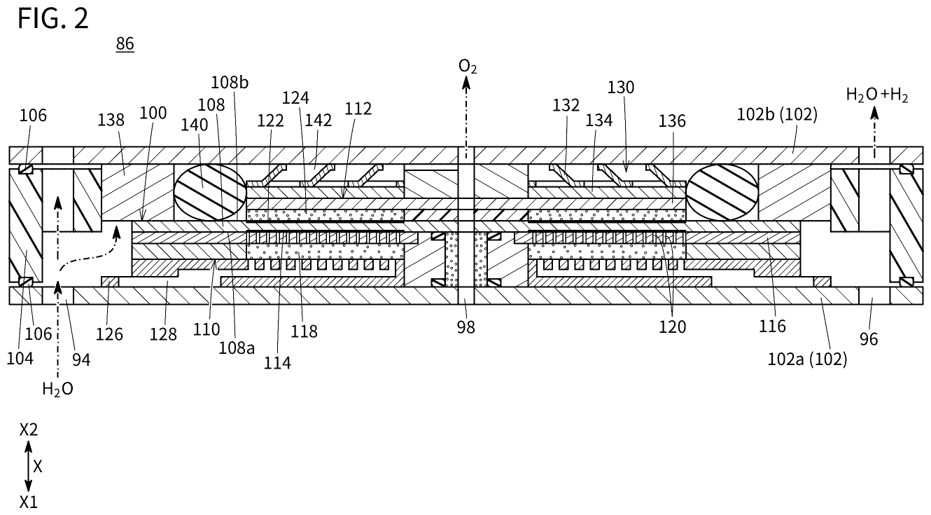

FIG. 2 is a cross-sectional explanatory diagram of the water electrolysis cells 86. In FIG. 2, the X direction is the stacking direction of the plurality of water electrolysis cells 86. As shown in FIG. 2, in the water electrolysis cells 86, water is supplied to a cathode 110. The water electrolysis cells 86, by electrolyzing the water, generate the oxygen gas at an anode 112 and the hydrogen gas at the cathode 110.

The water electrolysis cells 86 are differential pressure type water electrolysis cells in which the pressure of the oxygen gas at the anode 112 is higher than the pressure of the water at the cathode 110. Moreover, the water electrolysis cells 86 may be isobaric water electrolysis cells in which the pressure of the oxygen gas in the anode 112 is substantially equivalent to the pressure of the water inside the cathode 110. The water electrolysis device 60, for example, is capable of generating an oxygen gas of 14.7 MPa at the anode 112.

Water supply communication holes 94, water discharge communication holes 96, and oxygen gas discharge communication holes 98 that penetrate through the water electrolysis cells 86 in the X direction are provided in the water electrolysis cells 86. The water supply communication holes 94 of the plurality of water electrolysis cells 86 communicate mutually with one another. The water discharge communication holes 96 of the plurality of water electrolysis cells 86 communicate mutually with one another. The oxygen gas discharge communication holes 98 of the plurality of water electrolysis cells 86 communicate mutually with one another.

The water supply communication holes 94 and the water discharge communication holes 96 are provided on an outer peripheral part of the water electrolysis cells 86. The oxygen gas discharge communication holes 98 are provided in the center of the water electrolysis cells 86. The water supply communication holes 94 allow the water to be supplied to the cathode 110. The water discharge communication holes 96 allow the water that has flowed through the cathode 110 and the hydrogen gas that is generated at the cathode 110, to be discharged to the exterior. The oxygen gas discharge communication holes 98 allow the oxygen gas that is generated at the anode 112 to be discharged to the exterior.

Each of the water electrolysis cells 86 includes a membrane electrode assembly 100, a pair of separators 102, and a frame member 104. The membrane electrode assembly 100 is sandwiched and held between the pair of separators 102. The frame member 104 is formed in an annular shape in a manner so as to surround the membrane electrode assembly 100. A seal member 106 is disposed between the frame member 104 and the separators 102 in order to prevent fluids (the water and the hydrogen gas) from leaking out to the exterior.

The separators 102 are constituted, for example, by stainless steel. On the separators 102, there is coated a material containing, for example, niobium. Hereinafter, in FIG. 2, the separator 102 from among the pair of separators 102 that is positioned in the X1 direction of the membrane electrode assembly 100 may be referred to as a “first electrolytic separator 102a” and the separator 102 from among the pair of separators 102 that is positioned in the X2 direction of the membrane electrode assembly 100 may be referred to as a “second electrolytic separator 102b”.

The membrane electrode assembly 100 includes an electrolyte membrane 108, the cathode 110, and the anode 112. The electrolyte membrane 108 is sandwiched and held between the cathode 110 and the anode 112. The electrolyte membrane 108 is an ion exchange membrane. Specifically, the electrolyte membrane 108, for example, is a proton exchange membrane (PEM). The proton exchange membrane, for example, is a fluoropolymer membrane. Moreover, the electrolyte membrane 108 may be an anion exchange membrane (AEM). The electrolyte membrane 108 prevents the oxygen gas that is generated at the anode 112 from passing through to the cathode 110.

The cathode 110 includes a cathode catalyst layer 114, a protective sheet 116, and a cathode power feeder 118. The cathode catalyst layer 114 is joined to one surface 108a of the electrolyte membrane 108 (a surface of the electrolyte membrane 108 facing in the X1 direction). The cathode power feeder 118 also serves as a diffusion layer for supplying the water to the cathode catalyst layer 114. The cathode power feeder 118 has a portion that is formed by a porous material. The protective sheet 116 is disposed between the cathode catalyst layer 114 and the cathode power feeder 118. The protective sheet 116 prevents the electrolyte membrane 108 from suffering from damage when pressed against the cathode power feeder 118 by the high pressure oxygen gas that is generated in the anode 112. A plurality of through holes 120 are formed in the protective sheet 116.

The anode 112 includes an anode catalyst layer 122 and an anode power feeder 124. The anode catalyst layer 122 is joined to another surface 108b of the electrolyte membrane 108 (a surface of the electrolyte membrane 108 facing in the X2 direction). The anode catalyst layer 122 may be constituted, for example, by iridium, ruthenium, or the like. The anode power feeder 124 also serves as a gas diffusion layer for discharging the oxygen gas that is generated in the anode catalyst layer 122. The anode power feeder 124 has a portion that is formed by a porous material.

A supporting member 126 that supports the membrane electrode assembly 100 is provided between the first electrolytic separator 102a and the cathode power feeder 118. A communication path 128 is formed in the supporting member 126. The communication path 128 guides the water that is introduced from the water supply communication holes 94 into the cathode power feeder 118. Further, the communication path 128 guides a mixed fluid of the water and the hydrogen gas inside the cathode power feeder 118 to the water discharge communication holes 96.

A load applying mechanism 130, which serves to bias the anode power feeder 124 in the X1 direction, is provided between the second electrolytic separator 102b and the anode power feeder 124. The load applying mechanism 130 includes, for example, a leaf spring 132, a holder 134, and a conductive sheet 136.

An annular shaped member 138 is provided between the second electrolytic separator 102b and an outer peripheral part of the electrolyte membrane 108. The annular shaped member 138 is placed in liquidtight and airtight contact with respect to the other surface 108b of the electrolyte membrane 108.

An annular shaped seal member 140 is disposed between the annular shaped member 138 and the load applying mechanism 130. The seal member 140 is placed in liquidtight and airtight contact with respect to each of the second electrolytic separator 102b and the electrolyte membrane 108. A space (an anode chamber 142) in which the anode 112 is accommodated is formed on an inner side of the seal member 140. The load applying mechanism 130 is disposed in the anode chamber 142. The leaf spring 132 and the holder 134 that make up the load applying mechanism 130 are constituted, for example, by stainless steel. A material that includes, for example, niobium is coated on each of the leaf spring 132 and the holder 134.

As shown in FIG. 1, the first electrical power source 73 is a DC electrical power source. The first electrical power source 73 supplies an electrical current to the water electrolysis stack 72. Stated otherwise, the first electrical power source 73 applies a voltage between the cathode power feeder 118 and the anode power feeder 124 of each of the water electrolysis cells 86 (refer to FIG. 1 and FIG. 2).

The water electrolysis supply path 74 connects the gas/liquid separator 58 and the water electrolysis stack 72. The water electrolysis supply path 74 communicates with the water supply communication holes 94 (refer to FIG. 2) of the water electrolysis cells 86. The water electrolysis supply path 74 guides the water that is stored in the gas/liquid separator 58 to the water electrolysis stack 72. A water pump 143 is disposed in the water electrolysis supply path 74. The water pump 143 delivers the water that flows through the water electrolysis supply path 74 to the water electrolysis stack 72.

The water electrolysis discharge path 76 connects the gas/liquid separator 58 and the water electrolysis stack 72. The water electrolysis discharge path 76 communicates with the water discharge communication holes 96 (refer to FIG. 2) of the water electrolysis cells 86. The water electrolysis discharge path 76 guides to the gas/liquid separator 58 a mixed fluid of the hydrogen that is generated at the cathode 110 of the water electrolysis cells 86 and the water that has not been subjected to electrolysis. The gas/liquid separator 58 separates into a gas and a liquid a mixed fluid that is guided from the water electrolysis discharge path 76. Moisture that is separated from the mixed fluid is stored in the storage unit 70 of the gas/liquid separator 58.

The first oxygen gas transport path 78 communicates with the oxygen gas discharge communication holes 98 (refer to FIG. 2) of the water electrolysis cells 86. The first oxygen gas transport path 78 guides the oxygen gas that is generated by the water electrolysis stack 72 to the gas/liquid separator 80. The gas/liquid separator 80 separates into a gas and a liquid the oxygen gas that is guided from the first oxygen gas transport path 78. Stated otherwise, the gas/liquid separator 80 removes the moisture from the oxygen gas. The gas/liquid separator 80 is capable of storing the water (liquid water) that is separated from the oxygen gas.

The third drainage path 82 guides the water that is stored in the gas/liquid separator 80 to the gas/liquid separator 58. A third drainage valve 144 is provided in the third drainage path 82. The third drainage valve 144 is an opening/closing valve that opens and closes the third drainage path 82.

The second oxygen gas transport path 84 guides the oxygen gas from which the moisture has been removed by the gas/liquid separator 80 to the oxygen gas tank 22. A first back pressure valve 146 is provided in the second oxygen gas transport path 84. The first back pressure valve 146 opens in the case that the pressure of the oxygen gas that is guided from the water electrolysis stack 72 is greater than or equal to a predetermined oxygen gas pressure threshold value. The first back pressure valve 146 closes in the case that the pressure of the oxygen gas that is guided from the water electrolysis stack 72 is less than the oxygen gas pressure threshold value.

The water electrolysis device 60 can be equipped with constituent elements apart from those described above. The water electrolysis device 60 can be equipped with, for example, an ion exchange resin for converting the water that is supplied to the water electrolysis stack 72 into pure water.

The compression device 62 includes a compression stack 150, a second electrical power source 152, a compression supply path 154, a compression discharge path 156, a first hydrogen gas transport path 158, a gas/liquid separator 160, a fourth drainage path 162, and a second hydrogen gas transport path 164. The compression stack 150 serves to compress the hydrogen gas that is generated in the water electrolysis stack 72. The compression stack 150 includes a plurality of compression cells 166, and a pair of end plates 168. The plurality of compression cells 166 are stacked mutually on one another. The pair of end plates 168 sandwich and hold the plurality of compression cells 166 therebetween in the stacking direction of the plurality of compression cells 166.

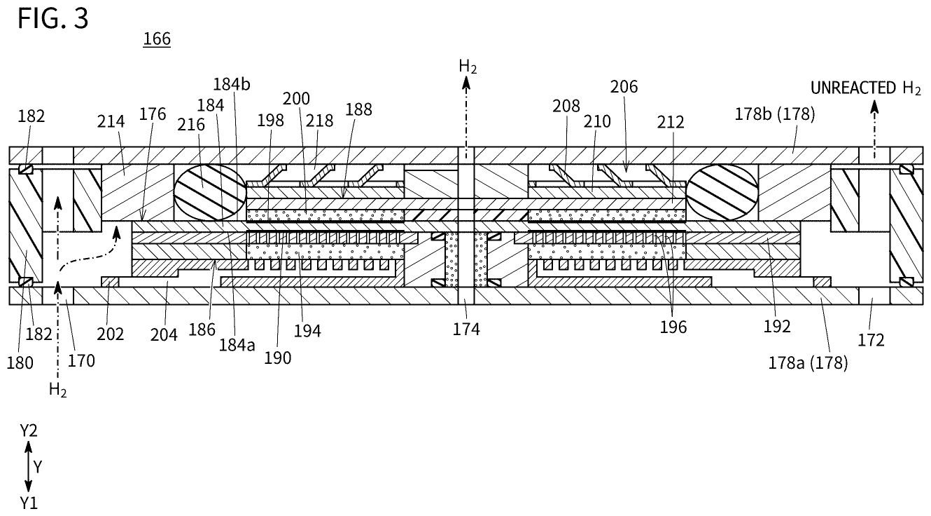

FIG. 3 is a cross-sectional explanatory diagram of the compression cells 166. In FIG. 3, the Y direction is the stacking direction of the plurality of compression cells 166. As shown in FIG. 3, in each of the compression cells 166, a humidified hydrogen gas is supplied to an anode 186. The compression cells 166, by supplying an electrical current to the anode 186 and a cathode 188, thereby cause a hydrogen gas to be generated at the cathode 188. In the compression device 62, for example, a hydrogen gas of 70 MPa can be generated at the cathode 188.

Supply communication holes 170, discharge communication holes 172, and hydrogen gas discharge communication holes 174, which penetrate in the Y direction through the compression cells 166, are provided in the compression cells 166. The supply communication holes 170 of the plurality of compression cells 166 communicate mutually with one another. The discharge communication holes 172 of the plurality of compression cells 166 communicate mutually with one another. The hydrogen gas discharge communication holes 174 of the plurality of compression cells 166 communicate mutually with one another.

The supply communication holes 170 and the discharge communication holes 172 are provided on an outer peripheral part of the compression cells 166. The hydrogen gas discharge communication holes 174 are provided in a center part of the compression cells 166. The supply communication holes 170 allow the hydrogen gas to be supplied to the anode 186. The discharge communication holes 172 allow the hydrogen gas (unreacted hydrogen gas) that has flowed through the anode 186, to be discharged to the exterior. The hydrogen gas discharge communication holes 174 allow the hydrogen gas that is generated at the cathode 188, to be discharged to the exterior.

Each of the compression cells 166 includes a membrane electrode assembly 176, a pair of separators 178, and a frame member 180. The membrane electrode assembly 176 is sandwiched and held between the pair of separators 178. The frame member 180 is formed in an annular shape in a manner so as to surround the membrane electrode assembly 176. A seal member 182 is disposed between the frame member 180 and the separators 178 in order to prevent fluids (the water and the hydrogen gas) from leaking out to the exterior.

The separators 178 are constituted, for example, by titanium. Hereinafter, in FIG. 3, the separator 178 from among the pair of separators 178 that is positioned in the Y1 direction of the membrane electrode assembly 176 may be referred to as a “first compression separator 178a” and the separator 178 from among the pair of separators 178 that is positioned in the Y2 direction of the membrane electrode assembly 176 may be referred to as a “second compression separator 178b”.

The membrane electrode assembly 176 includes an electrolyte membrane 184, the anode 186, and the cathode 188. The electrolyte membrane 184 is sandwiched and held between the anode 186 and the cathode 188. The electrolyte membrane 184 is an ion exchange membrane. Specifically, the electrolyte membrane 184, for example, is a proton exchange membrane (PEM). The proton exchange membrane, for example, is a fluoropolymer membrane. Moreover, the electrolyte membrane 184 may be an anion exchange membrane (AEM). The electrolyte membrane 184 prevents the hydrogen gas that is generated at the cathode 188 from passing through to the anode 186.

The anode 186 includes an anode catalyst layer 190, a protective sheet 192, and an anode power feeder 194. The anode catalyst layer 190 is joined to one surface 184a of the electrolyte membrane 184 (a surface of the electrolyte membrane 184 facing in the Y1 direction). The anode power feeder 194 also serves in a dual manner as a gas diffusion layer for supplying the hydrogen gas that is generated in the anode catalyst layer 190. The anode power feeder 194 has a portion that is formed by a porous material. The protective sheet 192 is disposed between the anode catalyst layer 190 and the anode power feeder 194. The protective sheet 192 prevents the electrolyte membrane 184 from suffering from damage when pressed against the anode power feeder 194 by the high pressure hydrogen gas that is generated in the cathode 188. A plurality of through holes 196 are formed in the protective sheet 192.

The cathode 188 includes a cathode catalyst layer 198, and a cathode power feeder 200. The cathode catalyst layer 198 is joined to another surface 184b of the electrolyte membrane 184 (a surface of the electrolyte membrane 184 facing in the Y2 direction). The cathode power feeder 200 also serves as a gas diffusion layer for discharging the hydrogen gas that is generated in the cathode catalyst layer 198. The cathode power feeder 200 has a portion that is formed by a porous material.

A supporting member 202 that supports the membrane electrode assembly 176 is provided between the first compression separator 178a and the anode power feeder 194. A communication path 204 is formed in the supporting member 202. The communication path 204 guides the water that is introduced from the supply communication holes 170 into the anode power feeder 194. Further, the communication path 204 guides an unreacted hydrogen gas inside the anode power feeder 194 to the discharge communication holes 172.

A load applying mechanism 206, which serves to bias the cathode power feeder 200 in the Y1 direction, is provided between the second compression separator 178b and the cathode power feeder 200. The load applying mechanism 206 includes, for example, a leaf spring 208, a holder 210, and a conductive sheet 212.

An annular shaped member 214 is provided between the second compression separator 178b and an outer peripheral part of the electrolyte membrane 184. The annular shaped member 214 is placed in liquidtight and airtight contact with respect to the other surface 184b of the electrolyte membrane 184.

An annular shaped seal member 216 is disposed between the annular shaped member 214 and the load applying mechanism 206. The seal member 216 is placed in liquidtight and airtight contact with respect to each of the second compression separator 178b and the electrolyte membrane 184. A space (a cathode chamber 218) in which the cathode 188 is accommodated is formed on an inner side of the seal member 216. The load applying mechanism 206 is disposed in the cathode chamber 218. The leaf spring 208 and the holder 210 that make up the load applying mechanism 206 are constituted, for example, by a material containing iron. A material that includes, for example, niobium is coated on each of the leaf spring 208 and the holder 210.

As shown in FIG. 1, the second electrical power source 152 is a DC electrical power source. The second electrical power source 152 supplies an electrical current to the compression stack 150. Stated otherwise, the second electrical power source 152 applies a voltage between the cathode power feeder 200 and the anode power feeder 194 of the compression cells 166 (refer to FIG. 1 and FIG. 2).

The compression supply path 154 connects the gas/liquid separator 58 and the compression stack 150. The compression supply path 154 guides the hydrogen gas inside the gas/liquid separator 58 to the compression stack 150. A hydrogen pump 220 is provided in the compression supply path 154. The hydrogen pump 220 delivers the hydrogen gas that flows through the compression supply path 154 to the compression stack 150. Moreover, an appropriate amount of water vapor is contained in the hydrogen gas that is supplied from the compression supply path 154 to the compression stack 150. In accordance with this feature, the electrolyte membrane 184 of each of the compression cells 166 is humidified by the water vapor.

The compression discharge path 156 connects the gas/liquid separator 58 and the compression stack 150. The compression discharge path 156 guides the unreacted hydrogen gas from the compression stack 150 together with the water vapor to the gas/liquid separator 58.

The first hydrogen gas transport path 158 communicates with the hydrogen gas discharge communication holes 174 (refer to FIG. 3) of the compression cells 166. The first hydrogen gas transport path 158 guides the hydrogen gas that is generated in the compression stack 150 to the gas/liquid separator 160. The gas/liquid separator 160 separates into a gas and a liquid the hydrogen gas that is guided from the first hydrogen gas transport path 158. Stated otherwise, the gas/liquid separator 160 removes the moisture from the hydrogen gas. The gas/liquid separator 160 is capable of storing the water (liquid water) that is separated from the hydrogen gas. The fourth drainage path 162 guides the water that is stored in the gas/liquid separator 160 to the gas/liquid separator 58. A fourth drainage valve 222 is provided in the fourth drainage path 162. The fourth drainage valve 222 is an opening/closing valve that opens and closes the fourth drainage path 162.

The second hydrogen gas transport path 164 guides the hydrogen gas from which the moisture has been removed by the gas/liquid separator 160 to the hydrogen gas tank 40. A second back pressure valve 224 is provided in the second hydrogen gas transport path 164. The second back pressure valve 224 opens in the case that the pressure of the hydrogen gas that is guided from the compression stack 150 is greater than or equal to a predetermined hydrogen gas pressure threshold value. The second back pressure valve 224 closes in the case that the pressure of the hydrogen gas that is guided from the compression stack 150 is less than the predetermined hydrogen gas pressure threshold value.

The compression device 62 can be equipped with constituent elements apart from those described above.

As shown in FIG. 1, the energy system 12 is equipped with a first ion measuring unit 226, a second ion measuring unit 228, a third ion measuring unit 230, a fourth ion measuring unit 232, and a fifth ion measuring unit 234. The first ion measuring unit 226 is provided in the water electrolysis device 60. The second ion measuring unit 228 is provided in the compression device 62. The third ion measuring unit 230 is provided in the gas/liquid separator 58. The fourth ion measuring unit 232 and the fifth ion measuring unit 234 are provided in the fuel cell system 14.

The first ion measuring unit 226 measures the amount of eluted ions eluted from the water electrolysis stack 72. The first ion measuring unit 226 measures the amount of eluted ions contained in the oxygen gas that is generated by the water electrolysis stack 72. Specifically, the first ion measuring unit 226 is provided in the gas/liquid separator 80 of the water electrolysis device 60. The first ion measuring unit 226 measures, for example, at predetermined time intervals, the amount of eluted ions existing in the water that is stored in the gas/liquid separator 80.

In the water electrolysis cells 86, fluoride ions may be eluted due to decomposition of the electrolyte membrane 108. In the water electrolysis cells 86, the coating on the separator 102, the leaf spring 132, and the holder 134 may peel off therefrom, and may thereby cause niobium ions to be eluted. Further, in the water electrolysis cells 86, iron ions may be eluted from the portions where the coating has peeled off. In the water electrolysis cells 86, iridium ions and ruthenium ions may be eluted due to the deterioration of the anode catalyst layer 122.

The first ion measuring unit 226 is capable of measuring, for example, fluorine ions, niobium ions, iron ions, iridium ions, ruthenium ions, and the like. The first ion measuring unit 226 may sequentially measure the amount of eluted ions existing in the water that is stored in the gas/liquid separator 80. The first ion measuring unit 226 may directly measure the amount of eluted ions eluted from the oxygen gas that is generated by the water electrolysis stack 72.

The second ion measuring unit 228 measures the amount of eluted ions eluted from the compression stack 150. The second ion measuring unit 228 measures the amount of eluted ions contained in the hydrogen gas that is generated by the compression stack 150. Specifically, the second ion measuring unit 228 is provided in the gas/liquid separator 160 of the compression device 62. The second ion measuring unit 228 measures, for example, at predetermined time intervals, the amount of eluted ions existing in the water that is stored in the gas/liquid separator 160.

In the compression cells 166, fluoride ions may be eluted due to decomposition of the electrolyte membrane 184. In the compression cells 166, the coating on the leaf spring 208 and the holder 210 may peel off therefrom, and may thereby cause niobium ions to be eluted. Further, in the compression cells 166, iron ions may be eluted from the portions where the coating has peeled off. In the compression cells 166, titanium ions may be eluted due to the deterioration of the separators 178.

The second ion measuring unit 228 is capable of measuring, for example, fluoride ions, niobium ions, iron ions, titanium ions, and the like. The second ion measuring unit 228 may sequentially measure the amount of eluted ions existing in the water that is stored in the gas/liquid separator 160. The second ion measuring unit 228 may directly measure the amount of eluted ions eluted from the hydrogen gas that is compressed in the compression stack 150.

The third ion measuring unit 230 is provided in the gas/liquid separator 58. The third ion measuring unit 230 measures, for example, at predetermined time intervals, the amount of eluted ions existing in the water that is stored in the gas/liquid separator 58. The third ion measuring unit 230 may sequentially measure the amount of eluted ions existing in the water that is stored in the gas/liquid separator 58.

The fourth ion measuring unit 232 is provided in the gas/liquid separator 28 of the fuel cell system 14. The fourth ion measuring unit 232 measures, for example, at predetermined time intervals, the amount of eluted ions existing in the water that is stored in the gas/liquid separator 28. The fourth ion measuring unit 232 may sequentially measure the amount of eluted ions existing in the water that is stored in the gas/liquid separator 28.

The fifth ion measuring unit 234 is provided in the gas/liquid separator 46 of the fuel cell system 14. The fifth ion measuring unit 234 measures, for example, at predetermined time intervals, the amount of eluted ions existing in the water that is stored in the gas/liquid separator 46. The fifth ion measuring unit 234 may sequentially measure the amount of eluted ions existing in the water that is stored in the gas/liquid separator 46.

Each of the third ion measuring unit 230, the fourth ion measuring unit 232, and the fifth ion measuring unit 234 is capable of measuring, for example, fluoride ions, niobium ions, iron ions, iridium ions, ruthenium ions, titanium ions, and the like.

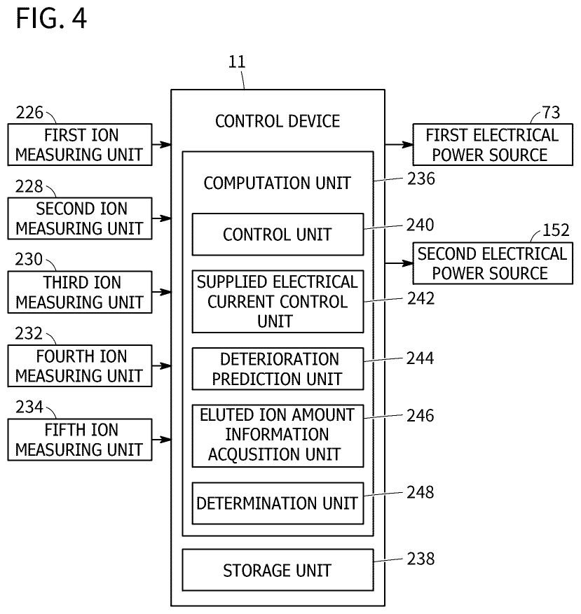

The energy system 12 is equipped with a control device 11. FIG. 4 is a block diagram for describing the control device 11. As shown in FIG. 4, the control device 11 is equipped with a computation unit 236, and a storage unit 238. The computation unit 236 is configured by a processor such as a CPU (Central Processing Unit) or a GPU (Graphics Processing Unit) or the like. More specifically, the computation unit 236 is constituted by a processing circuitry.

The computation unit 236 includes a control unit 240, a supplied electrical current control unit 242, a deterioration prediction unit 244, an eluted ion amount information acquisition unit 246, and a determination unit 248. The control unit 240 is responsible for the overall control of the energy system 12. The supplied electrical current control unit 242 controls the supplied electrical current that is supplied to the water electrolysis stack 72 and the supplied electrical current that is supplied to the compression stack 150. More specifically, the supplied electrical current control unit 242 controls the first electrical power source 73 and the second electrical power source 152. The deterioration prediction unit 244 predicts the degree of deterioration of each of the water electrolysis stack 72 and the compression stack 150. The eluted ion amount information acquisition unit 246 acquires first eluted ion amount information, and second eluted ion amount information. The first eluted ion amount information is information regarding the amount of eluted ions eluted from the water electrolysis stack 72. The second eluted ion amount information is information regarding the amount of eluted ions eluted from the compression stack 150.

The control unit 240, the supplied electrical current control unit 242, the deterioration prediction unit 244, the eluted ion amount information acquisition unit 246, and the determination unit 248 can be realized by the computation unit 236 executing a program that is stored in the storage unit 238. Moreover, at least a portion of the control unit 240, the supplied electrical current control unit 242, the deterioration prediction unit 244, the eluted ion amount information acquisition unit 246, and the determination unit 248 may be realized by an integrated circuit such as an ASIC (Application Specific Integrated Circuit) or an FPGA (Field-Programmable Gate Array) or the like. Further, at least a portion of the control unit 240, the supplied electrical current control unit 242, the deterioration prediction unit 244, the eluted ion amount information acquisition unit 246, and the determination unit 248 may be constituted by an electronic circuit including a discrete device.

The storage unit 238 is constituted by a non-illustrated volatile memory, and a non-illustrated non-volatile memory. As the volatile memory, there may be cited a RAM (Random Access Memory) or the like. The volatile memory is used as a working memory of the processor, and temporarily stores data and the like required for processing or calculations. As an example of the non-volatile memory, there may be cited a ROM (Read Only Memory) or a flash memory or the like. The non-volatile memory is used as a storage memory, and serves to store a program, a table, a map, and the like. At least a portion of the storage unit 238 may be provided in the aforementioned processor, the integrated circuit, or the like.

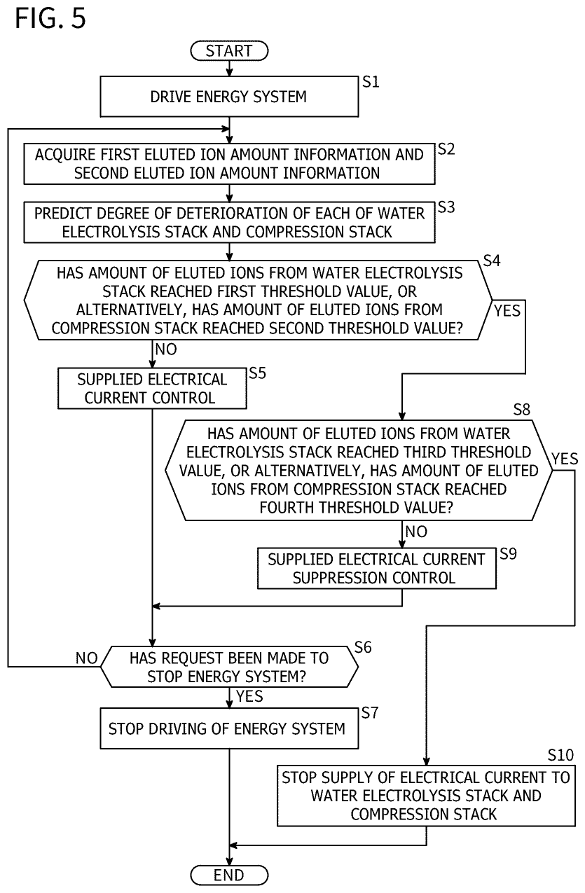

Next, a description will be given concerning the control of the electrolysis system 10. FIG. 5 is a flowchart for describing a method of controlling the electrolysis system 10.

As shown in FIG. 5, in step S1, the control unit 240 causes the energy system 12 to be driven. Specifically, as shown in FIG. 1, the control unit 240 controls the fuel cell system 14 and thereby starts the generation of electrical power. In particular, the control unit 240 controls the opening/closing valve 34 and thereby opens the oxygen gas supply path 24. Upon doing so, the oxygen gas that is filled in the oxygen gas tank 22 is supplied via the oxygen gas supply path 24 to the fuel cell stack 16. Further, the control unit 240 controls the opening/closing valve 52 and thereby opens the hydrogen gas supply path 42. Upon doing so, the hydrogen gas that is filled in the hydrogen gas tank 40 is supplied via the hydrogen gas supply path 42 to the fuel cell stack 16. The fuel cell stack 16 generates electrical power by means of an electrochemical reaction between the oxygen gas and the hydrogen gas. The electrical power that is generated by the fuel cell stack 16 can be used in order to cause the energy system 12 to be driven. Further, the electrical power that is generated by the fuel cell stack 16 can be used to charge a non-illustrated battery.

An oxygen exhaust gas (an off gas) from the fuel cell stack 16 is guided via the oxygen gas discharge path 26 to the gas/liquid separator 28. The gas/liquid separator 28 removes the moisture from the oxygen exhaust gas. The moisture that is removed from the oxygen exhaust gas is stored in the gas/liquid separator 28. The control unit 240 causes the oxygen pump 36 to be driven. In accordance with this feature, the oxygen exhaust gas from which the moisture has been removed is guided from the gas/liquid separator 28 via the oxygen gas circulation path 30 to the oxygen gas supply path 24.

A hydrogen exhaust gas (an off gas) from the fuel cell stack 16 is guided via the hydrogen gas discharge path 44 to the gas/liquid separator 46. The gas/liquid separator 46 removes the moisture from the hydrogen exhaust gas. The moisture that is removed from the hydrogen exhaust gas is stored in the gas/liquid separator 46. The control unit 240 causes the hydrogen pump 54 to be driven. In accordance with this feature, the hydrogen exhaust gas from which the moisture has been removed is guided from the gas/liquid separator 46 via the hydrogen gas circulation path 48 to the hydrogen gas supply path 42.

The control unit 240 controls the first drainage valve 38 to open the first drainage path 32, and also controls the opening/closing valve 68 to open the water supply path 64. Further, the control unit 240 causes the pump 66 to be driven. In accordance with this feature, the water that is stored in the gas/liquid separator 28 is introduced via the first drainage path 32 and the water supply path 64 into the gas/liquid separator 58. The drainage of water from the gas/liquid separator 28 to the gas/liquid separator 58 is carried out at an appropriate timing.

The control unit 240 controls the second drainage valve 56 to open the second drainage path 50, and also controls the opening/closing valve 68 to open the water supply path 64. Further, the control unit 240 causes the pump 66 to be driven. In accordance with this feature, the water that is stored in the gas/liquid separator 46 is introduced via the second drainage path 50 and the water supply path 64 into the gas/liquid separator 58. The drainage of water from the gas/liquid separator 46 to the gas/liquid separator 58 is carried out at an appropriate timing.

Further, the control unit 240 controls the water electrolysis device 60, and thereby causes the oxygen gas and the hydrogen gas to be generated. More specifically, the control unit 240 causes the water pump 143 to be driven, and also controls the first electrical power source 73 to supply an electrical current to the water electrolysis stack 72. When the water pump 143 is driven, as shown in FIG. 1 and FIG. 2, the water that is stored in the storage unit 70 of the gas/liquid separator 58 is supplied via the water electrolysis supply path 74 to the cathode 110 of the water electrolysis cells 86. As shown in FIG. 2, the water that is supplied to the cathode 110 moves inside the electrolyte membrane 108 from the cathode 110 to the anode 112. At the anode 112, the water is subjected to electrolysis and thereby generates the hydrogen ions and the oxygen gas. The hydrogen ions generated at the anode 112 move inside the electrolyte membrane 108 from the anode 112 to the cathode 110. At the cathode 110, the hydrogen ions combine and thereby generate the hydrogen gas. The water and the hydrogen gas that have been supplied to the cathode 110 but have not reacted are discharged via the water discharge communication holes 96 and the water electrolysis discharge path 76 to the gas/liquid separator 58 (refer to FIG. 1).

As shown in FIG. 1, the oxygen gas that is generated in the water electrolysis stack 72 is introduced via the first oxygen gas transport path 78 into the gas/liquid separator 80. The gas/liquid separator 80 removes the moisture from the oxygen exhaust gas. The moisture that is removed from the oxygen exhaust gas is stored in the gas/liquid separator 80. The water that is stored in the gas/liquid separator 80 is drained at an appropriate timing via the third drainage path 82 into the gas/liquid separator 58. The oxygen gas from which the moisture has been removed is guided to the second oxygen gas transport path 84. When the pressure of the oxygen gas that is generated in the water electrolysis stack 72 becomes greater than or equal to the oxygen gas pressure threshold value, the first back pressure valve 146 opens, and the oxygen gas is filled into the oxygen gas tank 22.

Furthermore, the control unit 240 controls the compression device 62 and thereby compresses the hydrogen gas. More specifically, the control unit 240 causes the hydrogen pump 220 to be driven, and controls the second electrical power source 152 to supply an electrical current to the compression stack 150. When the hydrogen pump 220 is driven, as shown in FIG. 1 and FIG. 3, the hydrogen gas in the gas/liquid separator 58 is supplied via the compression supply path 154 together with an appropriate amount of moisture to the anode 186 of the compression cells 166. As shown in FIG. 3, the hydrogen ions are generated at the anode 186. The hydrogen ions generated at the anode 186 move through the electrolyte membrane 184 from the anode 186 to the cathode 188. At the cathode 188, the hydrogen ions combine and thereby the hydrogen gas is generated. The hydrogen gas and the water that have been supplied to the anode 186 but have not reacted are returned via the discharge communication holes 172 and the compression discharge path 156 to the gas/liquid separator 58 (refer to FIG. 1).

As shown in FIG. 1, the hydrogen gas that is generated at the cathode 188 is guided via the first hydrogen gas transport path 158 to the gas/liquid separator 160. The gas/liquid separator 160 removes the moisture from the hydrogen gas. The moisture that is removed from the hydrogen gas is stored in the gas/liquid separator 160. The water that is stored in the gas/liquid separator 160 is drained at an appropriate timing via the fourth drainage path 162 into the gas/liquid separator 58. The hydrogen gas from which the moisture has been removed is guided to the second hydrogen gas transport path 164. When the pressure of the hydrogen gas that is generated in the compression stack 150 becomes greater than or equal to the hydrogen gas pressure threshold value, the second back pressure valve 224 opens and the hydrogen gas is filled into the hydrogen gas tank 40.

As shown in FIG. 5, after step S1, the process transitions to step S2. In step S2, the eluted ion amount information acquisition unit 246 acquires first eluted ion amount information and second eluted ion amount information. The first eluted ion amount information is information regarding the amount of eluted ions eluted from the water electrolysis stack 72. The first eluted ion amount information is information acquired based on the amount of eluted ions eluted within the oxygen gas that is generated by the water electrolysis stack 72. In the present embodiment, the eluted ion amount information acquisition unit 246 acquires the first eluted ion amount information based on the information that is output to the control device 11 from the first ion measuring unit 226. More specifically, the eluted ion amount information acquisition unit 246 is capable of acquiring information on the amount of eluted ions such as fluoride ions, niobium ions, iron ions, iridium ions, ruthenium ions, and the like. Moreover, the amount of eluted ions may be a concentration of the eluted ions, or may be an integrated value of the amount of eluted ions from a predetermined point in time.

The second eluted ion amount information is information regarding the amount of eluted ions eluted from the compression stack 150. The second eluted ion amount information is information acquired based on the amount of eluted ions eluted within the hydrogen gas that is compressed by the compression stack 150. In the present embodiment, the eluted ion amount information acquisition unit 246 acquires the second eluted ion amount information based on the information that is output to the control device 11 from the second ion measuring unit 228. More specifically, the eluted ion amount information acquisition unit 246 is capable of acquiring information on the amount of eluted ions such as fluoride ions, niobium ions, iron ions, titanium ions, and the like.

According to the present embodiment, in the case that one from among the first eluted ion amount information and the second eluted ion amount information is incapable of being acquired, and further, the other of the first eluted ion amount information and the second eluted ion amount information is capable of being acquired, then based on the information concerning the amount of eluted ions within the water that is stored in the storage unit 70 and the other from among the first eluted ion amount information and the second eluted ion amount information, the eluted ion amount information acquisition unit 246 estimates the one from among the first eluted ion amount information and the second eluted ion amount information.

Specifically, for example, in the case that the first ion measuring unit 226 breaks down, the eluted ion amount information acquisition unit 246 is incapable of acquiring the first eluted ion amount information from the first ion measuring unit 226. In this case, the eluted ion amount information acquisition unit 246 estimates the first eluted ion amount information based on, for example, information regarding the amount of eluted ions that are eluted in the water that is stored in the storage unit 70 of the gas/liquid separator 58 and the second eluted ion amount information. Moreover, the eluted ion amount information acquisition unit 246 is capable of acquiring information regarding the amount of eluted ions eluted in the water that is stored in the storage unit 70 of the gas/liquid separator 58 based on information that is output from the third ion measuring unit 230 to the control device 11.

The water that is stored in the storage unit 70 of the gas/liquid separator 58 contains ions eluted from the water electrolysis stack 72 and ions eluted from the compression stack 150. Stated otherwise, the ions eluted from the water electrolysis stack 72, together with the oxygen gas that is generated in the water electrolysis stack 72, are guided to the gas/liquid separator 28 via the first oxygen gas transport path 78, the gas/liquid separator 80, the second oxygen gas transport path 84, the oxygen gas tank 22, the oxygen gas supply path 24, the fuel cell stack 16, and the oxygen gas discharge path 26. In accordance with this feature, the ions eluted from the water electrolysis stack 72 are contained in the water that is stored in the gas/liquid separator 28 of the fuel cell system 14. The water that is stored in the gas/liquid separator 28 is guided via the first drainage path 32 and the water supply path 64 into the gas/liquid separator 58. Further, the water that is stored in the gas/liquid separator 80 of the water electrolysis device 60 can be drained via the third drainage path 82 into the storage unit 70 of the gas/liquid separator 58. In accordance with this feature, the eluted ions eluted from the water electrolysis stack 72 are contained within the water that is stored in the storage unit 70 of the gas/liquid separator 58.

The eluted ions eluted from the compression stack 150, together with the hydrogen gas that is compressed in the compression stack 150, are guided to the gas/liquid separator 46 via the first hydrogen gas transport path 158, the gas/liquid separator 160, the second hydrogen gas transport path 164, the hydrogen gas tank 40, the hydrogen gas supply path 42, the fuel cell stack 16, and the hydrogen gas discharge path 44. Therefore, the eluted ions eluted from the compression stack 150 are contained within the water that is stored in the gas/liquid separator 46 of the fuel cell system 14. The water that is stored in the gas/liquid separator 46 is guided via the second drainage path 50 and the water supply path 64 into the gas/liquid separator 58. Further, the water that is stored in the gas/liquid separator 160 of the compression device 62 can be drained via the fourth drainage path 162 into the storage unit 70 of the gas/liquid separator 58. In accordance with this feature, the eluted ions eluted from the compression stack 150 are contained within the water that is stored in the storage unit 70 of the gas/liquid separator 58.

Therefore, the eluted ion amount information acquisition unit 246 is capable of estimating the first eluted ion amount information based on information regarding the eluted ion amount in the water that is stored in the storage unit 70 of the gas/liquid separator 58 and the second eluted ion amount information. In this case, the eluted ion amount information acquisition unit 246 may take into consideration, for example, information regarding the amount of eluted ions within the water that is stored in the gas/liquid separator 28 of the fuel cell system 14, and information regarding the amount of eluted ions within the water that is stored in the gas/liquid separator 46 of the fuel cell system 14. In accordance with this feature, it is possible to estimate with even greater accuracy the first eluted ion amount information. Moreover, the eluted ion amount information acquisition unit 246 is capable of acquiring information regarding the amount of eluted ions eluted in the water that is stored in the gas/liquid separator 28 based on information that is output from the fourth ion measuring unit 232 to the control device 11. The eluted ion amount information acquisition unit 246 is capable of acquiring information regarding the amount of eluted ions eluted in the water that is stored in the gas/liquid separator 46 based on information that is output from the fifth ion measuring unit 234 to the control device 11.

Further, in the case that the second ion measuring unit 228 breaks down, the eluted ion amount information acquisition unit 246 is incapable of acquiring the second eluted ion amount information from the second ion measuring unit 228. In this case, the eluted ion amount information acquisition unit 246 estimates the second eluted ion amount information based on, for example, information regarding the amount of eluted ions within the water that is stored in the storage unit 70 of the gas/liquid separator 58 and the first eluted ion amount information. In this case, the eluted ion amount information acquisition unit 246 may take into consideration, for example, information regarding the amount of eluted ions within the water that is stored in the gas/liquid separator 28 of the fuel cell system 14, and information regarding the amount of eluted ions within the water that is stored in the gas/liquid separator 46 of the fuel cell system 14. In accordance with this feature, it is possible to estimate with even greater accuracy the second eluted ion amount information.

After step S2, the process transitions to step S3. In step S3, the deterioration prediction unit 244 predicts the degree of deterioration of each of the water electrolysis stack 72 and the compression stack 150. Specifically, the deterioration prediction unit 244 predicts the degree of deterioration of the water electrolysis stack 72 based on the first eluted ion amount information. More specifically, the deterioration prediction unit 244 is capable of predicting the degree of deterioration of the electrolyte membrane 108 of the water electrolysis stack 72, for example, based on information concerning the amount of eluted ions of the fluoride ions (the first eluted ion amount information). Further, the deterioration prediction unit 244 is capable of predicting the degree of deterioration of the anode catalyst layer 122 of the water electrolysis stack 72, for example, based on information concerning the amount of eluted ions of at least one type of ion selected from among the iridium ion and the ruthenium ion (the first eluted ion amount information). Furthermore, the deterioration prediction unit 244 is capable of predicting the degree of deterioration of the separators 102 and the like of the water electrolysis stack 72, for example, based on information concerning the amount of eluted ions of at least one type of ion selected from among the niobium ion and the iron ion (the first eluted ion amount information).

Further, the deterioration prediction unit 244 predicts the degree of deterioration of the compression stack 150 based on the second eluted ion amount information. More specifically, the deterioration prediction unit 244 is capable of predicting the degree of deterioration of the electrolyte membrane 184 of the compression stack 150, for example, based on information concerning the amount of eluted ions of the fluoride ions (the second eluted ion amount information). The deterioration prediction unit 244 is capable of predicting the degree of deterioration of the separators 178 and the like of the compression stack 150, for example, based on information regarding the amount of eluted ions of at least one type of ion selected from among the niobium ion, the iron ion, and the titanium ion (the second eluted ion amount information).

After step S3, the process transitions to step S4. In step S4, the determination unit 248, together with determining whether or not the amount of eluted ions eluted from the water electrolysis stack 72 has reached a first threshold value, determines whether or not the amount of eluted ions eluted from the compression stack 150 has reached a second threshold value. The first threshold value and the second threshold value are determined in advance and are stored in the storage unit 238. In the case that, together with it being determined by the determination unit 248 that the amount of eluted ions eluted from the water electrolysis stack 72 has not reached the first threshold value, it is determined by the determination unit 248 that the amount of eluted ions eluted from the compression stack 150 has not reached the second threshold value (NO in step S4), the process transitions to step S5.

In step S5, the supplied electrical current control unit 242 executes a supplied electrical current control. More specifically, the supplied electrical current control unit 242, together with controlling the electrical current that is supplied to the stack that is more degraded from among the water electrolysis stack 72 and the compression stack 150 to be constant, adaptively controls the electrical current that is supplied to the stack that is less degraded from among the water electrolysis stack 72 and the compression stack 150. In accordance with this feature, it is possible to suppress further deterioration of the water electrolysis stack 72 or the compression stack 150, whichever has the greater degree of deterioration.

In the water electrolysis stack 72, a portion of the hydrogen gas that is generated at the cathode 110 permeates through the electrolyte membrane 108 and is guided to the anode 112. The flow amount of the hydrogen gas that permeates through the electrolyte membrane 108 varies depending on the pressure inside the first oxygen gas transport path 78 and the temperature of the water electrolysis stack 72 and the like. Therefore, even if the electrical current that is supplied to the water electrolysis stack 72 and the compression stack 150 is constant, the amount of the hydrogen gas existing in the flow path (such as the gas/liquid separator 58 or the like) for guiding the hydrogen gas that is generated in the water electrolysis stack 72 to the compression stack 150 is not constant, and is likely to increase or decrease. In this case, the hydrogen gas may not be efficiently compressed by the compression stack 150.

However, according to the present embodiment, by adaptively controlling the electrical current that is supplied to the stack that is less degraded from among the water electrolysis stack 72 and the compression stack 150, it is possible to adjust the amount of the hydrogen gas existing inside the flow path (such as the gas/liquid separator 58 or the like) that guides the hydrogen gas that is generated in the water electrolysis stack 72 to the compression stack 150. More specifically, the amount of the hydrogen gas inside the gas/liquid separator 58 can be suppressed from becoming excessively small or becoming excessively large. Thus, the hydrogen gas can be efficiently compressed by the compression stack 150. Thereafter, the process transitions to step S6.

In step S6, the determination unit 248 determines whether or not a request has been made to stop the energy system 12 from being driven. In the case that it is determined by the determination unit 248 that a request has not been made to stop the energy system 12 from being driven (NO in step S6), the process transitions to step S2. In the case that it is determined by the determination unit 248 that a request has been made to stop the energy system 12 from being driven (YES in step S6), the process transitions to step S7.

In step S7, the control unit 240 stops the driving of the energy system 12. More specifically, the supplied electrical current control unit 242 stops the supply of the electrical current to the water electrolysis stack 72 and the compression stack 150. In accordance with this feature, the driving of the water electrolysis stack 72 and the compression stack 150 is stopped. Further, the control unit 240 stops the supply of the oxygen gas and the hydrogen gas to the fuel cell stack 16. Thereafter, the process shown in FIG. 5 comes to an end.

In the case that it is determined by the determination unit 248 that the amount of eluted ions eluted from the water electrolysis stack 72 has reached the first threshold value, or alternatively, it is determined by the determination unit 248 that the amount of eluted ions eluted from the compression stack 150 has reached the second threshold value (YES in step S4), the process transitions to step S8.

In step S8, the determination unit 248, together with determining whether or not the amount of eluted ions eluted from the water electrolysis stack 72 has reached the third threshold value, determines whether or not the amount of eluted ions eluted from the compression stack 150 has reached a fourth threshold value. The third threshold value is greater than the first threshold value. The fourth threshold value is greater than the second threshold value. The third threshold value and the fourth threshold value are determined in advance and are stored in the storage unit 238.

In the case that, together with it being determined by the determination unit 248 that the amount of eluted ions eluted from the water electrolysis stack 72 has not reached the third threshold value, it is determined by the determination unit 248 that the amount of eluted ions eluted from the compression stack 150 has not reached the fourth threshold value (NO in step S8), the process transitions to step S9.

In step S9, the supplied electrical current control unit 242 executes the supplied electrical current suppression control to suppress the electrical current that is supplied to the water electrolysis stack 72 and the compression stack 150. Specifically, the supplied electrical current control unit 242, in a state in which the electrical current that is supplied to the water electrolysis stack 72 and the compression stack 150 is suppressed, together with controlling the electrical current that is supplied to the stack having a larger degree of degradation from among the water electrolysis stack 72 and the compression stack 150 to be constant, adaptively controls the electrical current that is supplied to the stack having a smaller degree of deterioration from among the water electrolysis stack 72 and the compression stack 150. More specifically, the electrical current that is supplied to the water electrolysis stack 72 and the compression stack 150 in the supplied electrical current suppression control is smaller than the electrical current that is supplied to the water electrolysis stack 72 and the compression stack 150 in the supplied electrical current control (step S5). In accordance with this feature, while further suppressing the progress of further deterioration of the water electrolysis stack 72 and the compression stack 150, it is possible to efficiently compress the hydrogen gas by the compression stack 150. Thereafter, the process transitions to step S6.

In the case that it is determined by the determination unit 248 that the amount of eluted ions eluted from the water electrolysis stack 72 has reached the third threshold value, or alternatively, it is determined by the determination unit 248 that the amount of eluted ions eluted from the compression stack 150 has reached the fourth threshold value (YES in step S8), the process transitions to step S10.

In step S10, the supplied electrical current control unit 242 stops the supply of the electrical current to the water electrolysis stack 72 and the compression stack 150. In accordance with this feature, the driving of each of the water electrolysis stack 72 and the compression stack 150 is stopped. Thus, a further deterioration of the water electrolysis stack 72 and the compression stack 150 is prevented. In this case, the control unit 240 may stop the supply of the oxygen gas and the hydrogen gas to the fuel cell stack 16. Thereafter, the process shown in FIG. 5 comes to an end.

According to the present embodiment, the supplied electrical current control unit 242, together with controlling the electrical current that is supplied to the stack that is more degraded from among the water electrolysis stack 72 and the compression stack 150 to be constant, adaptively controls the electrical current that is supplied to the stack that is less degraded from among the water electrolysis stack 72 and the compression stack 150. In accordance with this feature, it is possible to suppress further deterioration of the water electrolysis stack 72 or the compression stack 150, whichever has the greater degree of deterioration. Further, since the amount of the hydrogen gas existing inside the flow path for guiding the hydrogen gas that is generated in the water electrolysis stack 72 to the compression stack 150 can be adjusted, the hydrogen gas can be efficiently compressed by the compression stack 150.

Concerning the above-described embodiment, the following supplementary notes are further disclosed.

### Supplementary Note 1

The control device (11) for the electrolysis system (10) is provided. The electrolysis system includes the water electrolysis device (60) configured to electrolyze the water by supplying the electrical current to the water electrolysis stack (72), and the compression device (62) configured to compress the hydrogen gas by supplying the electrical current to the compression stack (150) into which the hydrogen gas that is generated in the water electrolysis stack is introduced, wherein the control device for the electrolysis system includes the deterioration prediction unit (244) configured to predict the degree of deterioration of each of the water electrolysis stack and the compression stack, and the supplied electrical current control unit (242) configured to control the electrical current that is supplied to the water electrolysis stack and the electrical current that is supplied to the compression stack, and wherein the supplied electrical current control unit controls the electrical current that is supplied to the water electrolysis stack or the compression stack having the larger degree of deterioration to be constant, and adaptively controls the electrical current that is supplied to the water electrolysis stack or the compression stack having the smaller degree of deterioration.

In accordance with such a configuration, it is possible to suppress further deterioration of the water electrolysis stack or the compression stack, whichever the greater degree of deterioration. Further, since the amount of the hydrogen gas existing inside the flow path for guiding the hydrogen gas that is generated in the water electrolysis stack to the compression stack can be adjusted, the hydrogen gas can be efficiently compressed by the compression stack.

### Supplementary Note 2

In the control device for the electrolysis system according to Supplementary Note 1, there may further be provided the eluted ion amount information acquisition unit (246) configured to acquire the first eluted ion amount information which is information in relation to the amount of eluted ions eluted from the water electrolysis stack, and the second eluted ion amount information which is information in relation to the amount of eluted ions eluted from the compression stack, and the deterioration prediction unit may predict the degree of deterioration of the water electrolysis stack based on the first eluted ion amount information, and predict the degree of deterioration of the compression stack based on the second eluted ion amount information.

In accordance with such a configuration, the degree of deterioration of the water electrolysis stack can be predicted with high accuracy based on the first eluted ion amount information. Further, the degree of deterioration of the compression stack can be predicted with high accuracy based on the second eluted ion amount information.

### Supplementary Note 3

In the control device for the electrolysis system according to Supplementary Note 2, the first eluted ion amount information may be information acquired based on the amount of eluted ions in the oxygen gas that is generated by the water electrolysis stack, and the second eluted ion amount information may be information acquired based on the amount of eluted ions in the hydrogen gas that is compressed by the compression stack.

In accordance with such a configuration, the first eluted ion amount information and the second eluted ion amount information can be acquired with high accuracy.

### Supplementary Note 4

In the control device for the electrolysis system according to Supplementary Note 3, the electrolysis system may include the storage unit (70) configured to store the moisture contained in the off gas discharged from the fuel cell stack (16) configured to generate the electrical power by the electrochemical reaction between the oxygen gas produced by the water electrolysis stack and the hydrogen gas that is compressed by the compression stack, and the moisture discharged from the water electrolysis stack, and in the case that one from among the first eluted ion amount information and the second eluted ion amount information is incapable of being acquired, and further, the other of the first eluted ion amount information and the second eluted ion amount information is capable of being acquired, the eluted ion amount information acquisition unit may estimate one from among the first eluted ion amount information and the second eluted ion amount information, based on the information concerning the amount of eluted ions within the water that is stored in the storage unit and the other from among the first eluted ion amount information and the second eluted ion amount information.

In accordance with such a configuration, even if either the first eluted ion amount information or the second eluted ion amount information is incapable of being acquired, the level of deterioration of the water electrolysis stack and the compression stack can be predicted.

### Supplementary Note 5

In the control device for the electrolysis system according to Supplementary Note 2, there may be provided the determination unit (248) configured to determine whether or not the amount of eluted ions eluted from the water electrolysis stack has reached the first threshold value, and determine whether or not the amount of eluted ions eluted from the compression stack has reached the second threshold value, wherein, in the case that it is determined by the determination unit that the amount of eluted ions eluted from the water electrolysis stack has reached the first threshold value, or alternatively, in the case that it is determined by the determination unit that the amount of eluted ions eluted from the compression stack has reached the second threshold value, the supplied electrical current control unit may execute the supplied electrical current suppression control to suppress the electrical current that is supplied to the water electrolysis stack and the compression stack.

In accordance with such a configuration, in the case that at least one of the water electrolysis stack or the compression stack has deteriorated to a certain extent, the electrical current that is supplied to these stacks can be suppressed, and can thereby suppress the progression of further deterioration of the water electrolysis stack and the compression stack.

### Supplementary Note 6

In the control device for the electrolysis system according to Supplementary Note 5, the determination unit may determine whether or not the amount of eluted ions eluted from the water electrolysis stack has reached the third threshold value that is greater than the first threshold value, and determine whether or not the amount of eluted ions eluted from the compression stack has reached the fourth threshold value that is greater than the second threshold value, and in the case that it is determined by the determination unit that the amount of eluted ions eluted from the water electrolysis stack has reached the third threshold value, or alternatively, in the case that it is determined by the determination unit that the amount of eluted ions eluted from the compression stack has reached the fourth threshold value, the supplied electrical current control unit may stop supplying the electrical current to the water electrolysis stack and the compression stack.

In accordance with such a configuration, it is possible to cause the driving of the water electrolysis stack and the compression stack to be safely stopped prior to the water electrolysis stack and the compression stack becoming excessively deteriorated.

### Supplementary Note 7

The electrolysis system according to the present disclosure is equipped with the control device according to any one of Supplementary Notes 1 to 6.

It is possible to obtain the electrolysis system provided with the effects described in Supplementary Notes 1 to 6.

Although the present disclosure has been described in detail, the present disclosure is not necessarily limited to the specific embodiments described above. These embodiments can be subjected to various additions, substitutions, modifications, partial deletions and the like, within a range that does not depart from the essence and gist of the present disclosure, or alternatively, the spirit and gist of the present disclosure as derived from the contents described in the claims and their equivalents. Further, these embodiments can also be implemented in combination. For example, in the above-described embodiments, the order of the operations and the order of the processes are shown merely as examples, and the present invention is not necessarily limited to these examples. The same applies also in the case that numerical values or mathematical expressions are used in the description of the aforementioned embodiments.

1. A control device for an electrolysis system, the electrolysis system including:
a water electrolysis device configured to electrolyze water by supplying an electrical current to a water electrolysis stack; and
a compression device configured to compress a hydrogen gas by supplying an electrical current to a compression stack into which the hydrogen gas that is generated in the water electrolysis stack is introduced;
wherein the control device for the electrolysis system comprises at least one processor that executes computer-executable instructions stored in a memory, and
by the computer-executable instructions being executed by the at least one processor, the control device is configured to:
predict a degree of deterioration of each of the water electrolysis stack and the compression stack;
control an electrical current that is supplied to the water electrolysis stack and an electrical current that is supplied to the compression stack; and
control the electrical current that is supplied to the water electrolysis stack or the compression stack having a larger degree of deterioration to be constant, and adaptively control the electrical current that is supplied to the water electrolysis stack or the compression stack having a smaller degree of deterioration.

2. The control device for an electrolysis system according to claim 1, wherein the at least one processor causes the control device to:
acquire first eluted ion amount information which is information in relation to an amount of eluted ions eluted from the water electrolysis stack, and second eluted ion amount information which is information in relation to an amount of eluted ions eluted from the compression stack; and
predict the degree of deterioration of the water electrolysis stack based on the first eluted ion amount information, and predict the degree of deterioration of the compression stack based on the second eluted ion amount information.

3. The control device for an electrolysis system according to claim 2, wherein:
the first eluted ion amount information is information acquired based on the amount of eluted ions in the oxygen gas that is generated by the water electrolysis stack; and
the second eluted ion amount information is information acquired based on the amount of eluted ions in the hydrogen gas that is compressed by the compression stack.

4. The control device for an electrolysis system according to claim 3, wherein:
the electrolysis system comprises a storage unit configured to store moisture contained in an off gas discharged from a fuel cell stack configured to generate electrical power by an electrochemical reaction between an oxygen gas produced by the water electrolysis stack and a hydrogen gas that is compressed by the compression stack, and moisture discharged from the water electrolysis stack; and
in a case that one from among the first eluted ion amount information and the second eluted ion amount information is incapable of being acquired, and further, another of the first eluted ion amount information and the second eluted ion amount information is capable of being acquired, the at least one processor causes the control device to estimate the one from among the first eluted ion amount information and the second eluted ion amount information, based on information concerning the amount of eluted ions within water that is stored in the storage unit and the other from among the first eluted ion amount information and the second eluted ion amount information.

5. The control device for an electrolysis system according to claim 2, wherein:
the at least one processor causes the control device to determine whether or not the amount of eluted ions eluted from the water electrolysis stack has reached a first threshold value, and determine whether or not the amount of eluted ions eluted from the compression stack has reached a second threshold value; and
in a case that it is determined that the amount of eluted ions eluted from the water electrolysis stack has reached the first threshold value, or alternatively, in a case that it is determined that the amount of eluted ions eluted from the compression stack has reached the second threshold value, the at least one processor causes the control device to execute a supplied electrical current suppression control to suppress the electrical current that is supplied to the water electrolysis stack and the compression stack.

6. The control device for an electrolysis system according to claim 5, wherein:
the at least one processor causes the control device to determine whether or not the amount of eluted ions eluted from the water electrolysis stack has reached a third threshold value that is greater than the first threshold value, and determine whether or not the amount of eluted ions eluted from the compression stack has reached a fourth threshold value that is greater than the second threshold value; and
in a case that it is determined that the amount of eluted ions eluted from the water electrolysis stack has reached the third threshold value, or alternatively, in a case that it is determined that the amount of eluted ions eluted from the compression stack has reached the fourth threshold value, the at least one processor causes the control device to stop supplying the electrical current to the water electrolysis stack and the compression stack.

7. An electrolysis system equipped with the control device according to claim 1.
